(19) United States
(12) Patent Application Publication
(10) Pub. No.: US 2009/0144091 A1
(43) Pub. Date: Jun. 4, 2009

(54) MEDICAL PRODUCT MANAGEMENT METHODS

(75) Inventor: Angelo Rago, Walnut Creek, CA (US)

Correspondence Address: ABBOTT MEDICAL OPTICS, INC., 1700 E. ST. ANDREW PLACE, SANTA ANA, CA, 92705, US

(73) Assignee: Advanced Medical Optics, Inc., Santa Ana, CA (US)

(21) Appl. No.: 12/327,391

(22) Filed: Dec. 3, 2008

Related U.S. Application Data
(60) Provisional application No. 61/005,459, filed on Dec. 3, 2007.

(51) Int. Cl. G06Q 50/00; G06Q 90/00

(52) U.S. Cl. 705/3; 705/2; 705/30

(57) ABSTRACT

A method for providing a medical product including receiving a request for a medical product for use with a specific patient to be used at a particular location, and creating a patient specific package which includes the medical product. The method further includes associating at least one of the patient specific package or the medical product with the specific patient, and causing the patient specific package to be delivered to the particular location.

This application claims priority to U.S. provisional patent application Ser. No. 61/005,459, filed on Dec. 3, 2007, the entire contents of which are hereby incorporated by reference.

The present design relates generally to a system and method for distributing medical products, and more particularly, for distributing medical products to facilities for use in medical procedures.

### BACKGROUND

Many medical products, items, devices and consumables (collectively termed “products” herein) are utilized in medical procedures. For example products such as intra-ocular lenses (“IOL”s), artificial joints, and the like may be implanted in patients in surgical procedures. Medical devices are often produced or manufactured at a first location (i.e. at a manufacturing facility) and implanted or utilized at a second location (i.e. at a hospital, physician's office, or an ambulatory surgical center (“ASC”)). This second location is generically referred to herein as a “facility.”

Under existing methods of delivery and distribution, the facility orders a number of the products from the manufacturer or distributor. The facility then maintains the products on hand for use by a surgeon as needed. The facility may maintain so-called generic products, which are products that are not patient-specific and can be used in a procedure irrespective of the specific patient. Examples of generic product are needles, tubes, gloves, sterile supplies, etc. A facility may retain generic products on hand in quantities sufficient to cover expected usage of those products over a particular period of time, and then replenish supplies of those generic products as needed. However, this method requires the facility to provide storage for a relatively high number of products, thereby incurring storage and overhead costs.

Another issue with maintaining products at the facility arises when the facility stores, supplies and/or uses patient specific products, such as artificial joints, IOLs, etc. Unlike generic products, patient specific products have properties that are selected for use in a particular patient. In this case, each patient specific product can have a large number of variations as to size, prescription, materials, manufacturer, etc. Thus, in order to anticipate the need for a particular patient specific product, the facility must pre-order and keep on hand a significant number of patient specific products having a variety of parameters in an attempt to accommodate each specific need that may arise. In certain cases facilities may be required to store hundreds, or possibly thousands, of patient specific medical products, which requires significant space and increases storage costs.

Some medical products are provided on a consignment basis. In this case the products are shipped to the facility by the manufacturer, but the facility is not billed by the manufacturer until the products are actually used. In such cases the facility may periodically take an inventory of unused products to determine the number of products that have been used since the last inventory. The facility then informs the manufacturer of the number of products used by the facility and orders replacement products. In this case the manufacturer may have delivered products to the facility some time ago, but may not receive word that a product has been used until the facility updates its inventory (which can be weeks, or even months, after the product has been employed or otherwise used). Thus, in this case the manufacturer incurs up-front delivery and product costs, but may not receive payment until a much later date, which increases manufacturer costs due to the time value of money. This problem can be compounded if the facility's count of inventory is not accurate, or if certain products are not (or sometimes are never) used or expire.

Further issues exist with respect to tracking information and data. Presently, data related to use of products and the patient using the particular product is maintained sparsely, if at all, and typically only at the facility or by the performing physician.

### SUMMARY

In one embodiment, the invention includes a method for providing a medical product including receiving a request for a medical product for use with a specific patient to be used at a particular location, and creating a patient specific package which includes the medical product. The method further includes associating at least one of the patient specific package or the medical product with the specific patient, and causing the patient specific package to be delivered to the particular location.

In another embodiment, the invention includes a method for collecting information relevant to specific medical concerns. The method comprises distributing a plurality of medical products for use in medical procedures. At least a portion of the medical products distributed are provided from distribution sites in patient specific packages, thereby enabling data collection of the contents of patient specific packages and associated patient data. The method further comprises accumulating patient specific package data and associated patient data for pertinent procedures performed using the medical products distributed.

### BRIEF DESCRIPTION OF THE DRAWINGS

The present invention and design is illustrated by way of example, and not by way of limitation, in the figures of the accompanying drawings in which:

FIG. 1 is a functional block diagram of various entities providing medical products in one embodiment of the invention;

FIG. 2 is a flow diagram of one aspect of the present invention; and

FIG. 3 is a functional block diagram illustrating the flow of information, products, and patient specific packages in one embodiment of the invention.

### DETAILED DESCRIPTION

The following description and the accompanying drawings illustrate certain specific embodiments to enable one skilled in the art to practice the present system and method. However, it should be understood that other embodiments of the system and method may incorporate structural, logical, process and other changes from the examples and drawings shown herein, and the examples provided herein merely typify possible embodiments. Individual components and functions described and shown herein are generally optional unless explicitly indicated to be required, and the sequence of operations described and shown herein may vary. Portions and features of some embodiments may be included in or substituted for those of others.

While the present design will be described in detail with respect to medical products generally, and ophthalmic products, such as IOLs in many instances, it is to be understood that the current invention and design may be used with and apply to other areas and products, including but not limited to joint replacements, implants such as breast implants and the like, blood or other bodily fluid, artificial organs, transplantable organs, pharmaceuticals, glaucoma shunts, retinal or cochlear implants, pacemakers, multiple counts of a single product, and virtually any medical product or situation wherein a trackable product is utilized. In addition, the system and method described herein is not restricted to use in the medical field, and can be used in a variety of other settings, such as in veterinarian operations, manufacturing operations, business operations, handling, shipping and/or storage operations, assembly operations or in the fields of office supply, automotive repair, food service, computer repair, home repair, retail stores, etc., or nearly any setting in which products (particularly inventoried or uniquely-identified products) and/or events are desired to be tracked. Thus, if an item can be tracked, the current invention and design may be employed at least to some degree.

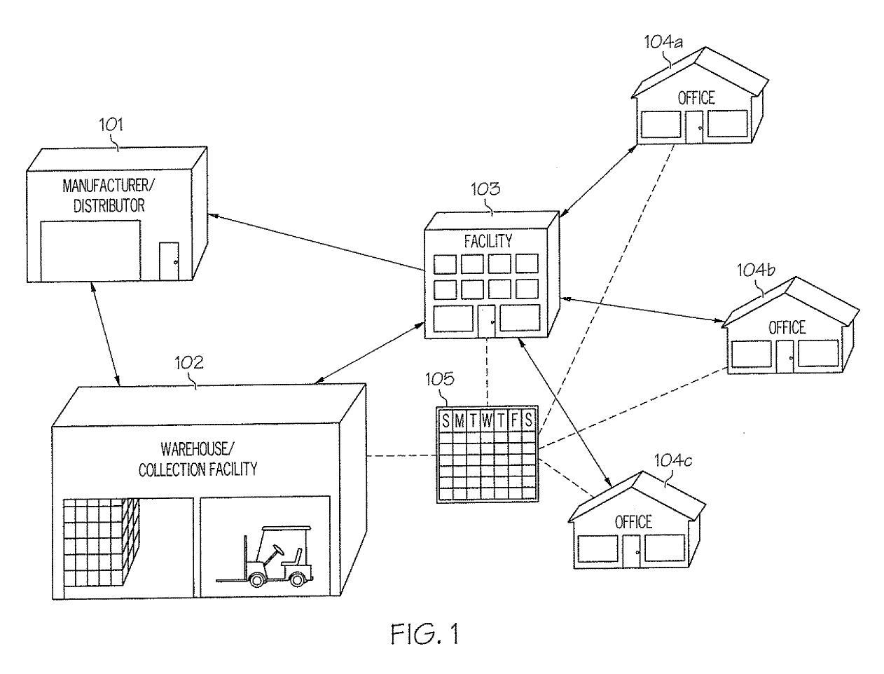

One embodiment of the present design is shown in FIG. 1, which illustrates a manufacturer/distributor lot of a medical product. The manufacturer 101 may be the original equipment manufacturer (“OEM”) or a distributor of a product. The manufacturer 101 may provide products to a collection facility or warehouse 102 that is geographically positioned to service an efficient and/or desired number of facilities 103. A number of warehouses 102 may be positioned in a geographic region, such as a particular country, or parts thereof, such as states, regions or provinces. While no specific number is required or mandated, it may be that at least one and perhaps ten or more warehouses 102 may be employed in geographically logical regions throughout, for example, the United States or some other country. Each warehouse 102 may service multiple facilities 103, wherein each facility 103 is a location where surgical procedures are performed and/or products are employed, or a location where products are received and either held, transferred, or employed. For example a facility 103 may be, but is not limited to, physician's or doctor's offices, hospitals, ASCs, optometrist's offices or other locations where the medical product is used or stored. While a manufacturer 101 is shown in FIG. 1, the entity originating the product may be a distributor or other entity that does not strictly manufacture the product, and the warehouse 102 may be a distributor or entity tasked with assembling the patient specific package.

It should be noted that while a single manufacturer 101, warehouse 102, and facility 103 are shown in FIG. 1, and three offices 104a-c are shown in FIG. 1 for illustration purposes, more or fewer of each of these locations/entities may be employed. In addition, the functionality of one or more of the entities may be combined. For example, in a large hospital setting, the offices 104a-c may be located within a facility 103, which could, in turn, be located, or be part of, a hospital or other similar facility. Further, a facility 103 may be associated with or on the same grounds as a warehouse 102, and/or a warehouse 102 may be located at a site of a manufacturer 101, etc.

The warehouse 102 has the ability to receive, store and ship products from the manufacturer 101. The warehouse 102 interacts with a series of facilities 103, which for illustrative purposes herein may be considered to be an ASC. The facility/ASC 103 interacts with offices 104a-c, which represent locations where medical personnel, such as physicians, typically conduct business and medical examinations. Thus, the offices 104a-c may be, but are not limited to, physician's offices or the like.

In the normal course of treatment, a patient may be examined at a physician's office 104, but may also or instead be examined elsewhere, such as at a hospital, emergency room, outpatient facility, etc. As a result of the examination, it may be determined that the patient requires a procedure and/or use of a medical product. In such a circumstance, the patient may be scheduled for a procedure at a particular time at a given location, such as a facility/ASC 103. Each facility/ASC 103 may be set up to enable a physician or practitioner to perform the procedure, and implant or otherwise utilize the medical product. For example, ASC/facility 103 may maintain expensive and/or bulky equipment that is not typically found at a physician's office 104, but can instead be shared by multiple physicians. The ASC/facility 103 may also maintain a staff that can perform, or aid in performing, the particularized procedure and implanting or otherwise utilizing particular medical products.

In one scenario, the physician may see the patient in his office 104 and, based on the visit, determine that it is appropriate to implant an IOL in the patient. The physician or his staff may schedule a surgical procedure at an ASC/facility 103 at a particular time, specifying the procedure and/or the products (an IOL and other ancillary products) as desired.

Each physician may have a “preference card” associated with that physician which lists the products, equipment and supplies typically used by, or required to be on-hand by, a physician for a particular procedure. In this manner, once the identity of the physician and the type of procedure is known, the needed products can be quickly identified by referencing the appropriate preference card.

The preference cards/data may be maintained by the offices 104, in which case the offices 104 may provide a list of products and equipment to the facility 103 which are required for a particular procedure. For example, the preference card for a certain procedure and physician may specify three needles, a first IOL having a first diopter, a second IOL having a second diopter, the use of a phacoemulsification machine, a video camera for recording the procedure, and various related products such as gloves, masks, gowns, and so forth. This data is then forwarded to the facility 103.

Alternately, or in addition to having the offices 104 maintaining the preference cards, the facility 103 may also maintain the preference cards/data. In this case, the office 104 need only identify the physician and procedure, and the facility 103 can reference its database of preference cards to identify which products and equipment are desired/required.

The information transferred from the office 104 to the facility 103 (i.e. identity of the physician, type of procedure, identity of the patient, a list of products, etc.), and indeed, all communication between the offices 104, facility 103, warehouse 102 and manufacturer 101 can be through any reasonable channels, including but not limited to telephone, computer transmission (including via the internet and/or email), facsimile transmission, VPN, mobile phone, PDA, wireless network, EDI, wireless or satellite communications, or by other communication means.

When the office 104 contacts the facility 103, the office 104 may seek to schedule/reserve a time for the procedure. Each office 104 and the facility 103 may be electronically linked or otherwise share data such that an interactive electronic calendar 105 is maintained. Each operating room of the facility 103 may have a status indicator for each hour of each day (i.e. either open or scheduled/reserved). If a room is scheduled for a particular time, certain information (such as the name of the patient, the name of the associated physician, the type of procedure, the products and equipment to be utilized) or other indicia (i.e. the text “reserved” or the like) may be displayed to signal that the room is scheduled.

A room that is indicated to be open or unscheduled can be reserved by clicking on the associated link. All of the relevant information for the procedure to be scheduled can be entered in a form presented in a new window or screen. Once the relevant information is entered into the reservation form, the information is stored and the status indicator for the room is changed to “reserved” for the appropriate time period. In the manner, the physician's office 104 receives immediate, real-time feedback as to the availability of the facility 103 for procedures, as well as the availability of other associated items.

The scheduling system provides a visual, user-friendly representation of scheduled events and allows the user to check and modify information and schedules as desired. Alternately, procedures can be scheduled in a more traditional manner; that is, via phone, personal interaction, etc. In this case, if a conflict exists, the conflict is noted and the facility 103 can contact the office 104 to reschedule.

Upon receiving the relevant information regarding the upcoming procedure, if no conflict exists the facility 103 typically schedules the procedure and links the patient, physician, and associated products and equipment. Thus, both the physician and the patient may have unique identifiers to enable the information to be associated therewith. The facility 103 may assign a particular status to the procedure, depending upon certain conditions. For example, in order for a procedure to proceed, the following conditions may be required to be met: 1) the facility must have available space (i.e. an available operating room) and appropriate equipment; 2) the physician (and any associated/essential staff) must be available; and 3) the appropriate products must be available, or be available by the time of the procedure.

If condition 1) is not met (i.e. all of the operating rooms at that facility 103 are unavailable or the necessary equipment is unavailable), then the facility 103 may prevent the procedure from being scheduled. Alternately, the facility 103 may allow the procedure to be scheduled, but may associate warning indicia with the scheduled information (i.e. the scheduled information may be shown in red) and the scheduling may be considered to be tentative.

The scheduling system may also have access to the schedules/calendars of physicians and staff which may be part of the calendar system 105. In this manner, if condition 2) is not met (i.e. the desired physician and/or certain designated or essential staff members are unavailable), then the facility 103/scheduling system may prevent the procedure from being scheduled. Alternately, the facility 103 may allow the procedure to be tentatively scheduled, but may associate warning indicia with the scheduled information (i.e. the scheduled information may be shown in red).

The scheduling system may also have access to the inventory for the facility 103. In this case if condition 3) is not met (i.e. products identified as necessary for the procedure are not on hand), then the facility 103/scheduling system may prevent the procedure from being scheduled. Alternately, the facility 103 may allow the procedure to be tentatively scheduled, but may associate warning indicia with the scheduled information. Further alternately, the facility 103 may allow the procedure to be scheduled, but may associate a more mild warning indicia with the scheduled information (i.e. the color yellow) if it is determined that the necessary products are not currently on-hand, but are obtainable by the date of the procedure. In this manner, although the scheduled information may initially be shown in yellow, once all of the necessary products are on-hand at the facility (and conditions 1) and 2) are met), the status indicator may change to green, thereby indicating that there are no barriers to the procedure moving forward.

Once the procedure is scheduled, and in advance of the date/time for the scheduled procedure, the facility 103 alerts the collection facility or warehouse 102 and requests from the warehouse 102 medical products that are required for the upcoming scheduled procedure. The request may be for all or some of the required medical products, as some products may already be on hand at the facility, and/or other products may be secured by the facility 103 from other sources.

The facility 103 may send a direct request to the warehouse 102. Alternately, the facility 103 may provide with the warehouse 102 with access to the calendar/scheduling system 105 so that the warehouse 102 can view upcoming scheduled procedures and anticipate demand. The warehouse 102 may receive an indication of the products to be used, or may simply receive information relating to the procedure so that the warehouse 102 can itself identify the necessary products, in the same manner as can be done by the facility 103 described above. Once the warehouse 102 receives a request from the facility 103, or otherwise receives an indication of need, the warehouse 102 prepares at least one “patient specific package,” which is specifically associated with a particular patient and/or procedure, and/or includes products specifically associated with a particular patient and/or procedure. The products in a patient specific package may include any trackable product or item, and may include, by way of example, an IOL, an artificial joint, units of blood, artificial or transplantable organs, pharmaceuticals, or the other products listed above associated with a medical procedure or other procedure. As an ophthalmic example, a patient specific package may contain one or more of the following products: an IOL for one eye, or specific IOLs for each eye of a given patient; an IOL insertion device; forceps; a phacoemulsification tubing pack; drapes; gloves; BSS solutions; viscoelastics; and so forth based on the procedure and/or physician preferences.

The shape or form of the patient specific package can vary and may take any reasonable form. Thus the patient specific package may take the form of a physical package, such as a sealed or sealable plastic bag or box with patient and/or procedure information provided thereon or associated therewith, and/or with facility information provided thereon. The patient specific package may also take the form of products that are collected and fastened together, or not physically linked but electronically linked or associated in a database. Thus the patient specific package may not necessarily be a single physically defined package, but could instead include multiple packages or items. Moreover, a single physical package could house more than one patient specific package. The various products in one or more patient specific packages may be provided from multiple different warehouses 102/manufacturers 101.

In one case, the patient specific package includes only products for a single procedure associated with a single patient. However, a patient specific package may include products for multiple procedures for a patient. For example, a patient specific package may include products for a left eye ocular surgery, and may also include products for a right eye ocular surgery for the same patient to take place at a later time.

Transportation of the patient specific package from the warehouse 102 to the facility 103 may be by any reasonable means, including shipment by postal service or private carrier, shipment by warehouse personnel, facility personnel or office personnel, or by nearly any other transportation method. The patient specific package is delivered to the facility 103 in advance of the scheduled procedure. Thus, by providing a predictable and reliable method for supplying products to the facility 103 in advance of an associated procedure, the facility 103 can reduce the products maintained on hand, thereby reducing the storage requirements and overhead.

While FIG. 1 shows a manufacturer 101, it should be noted that the entity originating the product may be a distributor or other entity that does not itself manufacture the product. Further, an office 104 may have the ability to request a package directly from the warehouse 102. Alternately, the facility 103 may request the package from the manufacturer 101 for forwarding to the facility 103 directly, or via the warehouse 102. In all circumstances, however, at least one patient specific package is prepared and provided at a facility 103 for the patient in advance of the procedure.

A reasonable number of backup products may be stored/held at the facility 103. However, these backup products may be maintained for use only in cases of emergency, such as when there is insufficient time to receive products, or needed products are lost or broken in transit, or a particular product, upon receipt and inspection, is found to not comply with medical requirements, etc. However, the emergency quantity maintained on hand at the facility 103 would be expected to be significantly reduced compared to the large number of products required to be stored under the consignment method of product delivery.

The present invention and design enables tracking of the medical products. For example, when an artificial hip is being implanted, the facility 103 may order or place a request for the artificial hip, along with a request for other (possibly associated) medical products. The warehouse 102 receives the order from the facility 103 ships the artificial hip to the facility 103 in a package that is to arrive in advance of the scheduled procedure. The package may include, or otherwise be associated with, certain patient pertinent information, such as the name of patient, name of physician, type of procedure, date of procedure, a photograph or other means of identifying the patient, a tracking number or identifier, etc. The artificial hip may be the most critical component in the package, and it may have its own separate tracking number or unique identifier. Once the patient specific package is received at the facility 103, the package and its tracking number and identifier may be entered, scanned and retained at the facility 103.

After the artificial hip has been implanted in the patient, the facility 103 may notify the warehouse 102 and/or manufacturer 101 that the products in the package, including the artificial hip, have been used/implanted. When the manufacturer 101 receives indication that the products have been used, the manufacturer 101 can bill the appropriate entity for payment for the products. In this case the manufacturer is promptly notified of the use of the products, which can vastly reduce the time required to receive payment compared to the consignment arrangement described above.

As an example and not by way of limitation, each package may have a package tracking number that incorporates a warehouse tracking number/identifier, and tracking numbers/identifiers for each product in that package. Each of these tracking numbers may recorded and/or scanned at the facility 103 upon receipt, such as by manual entry, barcode or RFID scanner, downloading from a readable chip, USB device or software attached to or associated with the package, or other methods. Related information (package number, warehouse number, product/product number, etc.) may be recorded or stored at the facility 103 or by an entity associated with facility 103, and the information sent to the manufacturer 101 as appropriate. If desired, only information relevant to that manufacturer 101 may be sent. For example, if the manufacturer 101 provides needles (and not breast implants), and a package shipped from the facility 103 to an office 104 includes needles and another manufacturer's breast implant, the manufacturer 101 may only need to be advised as to the needles in the package.

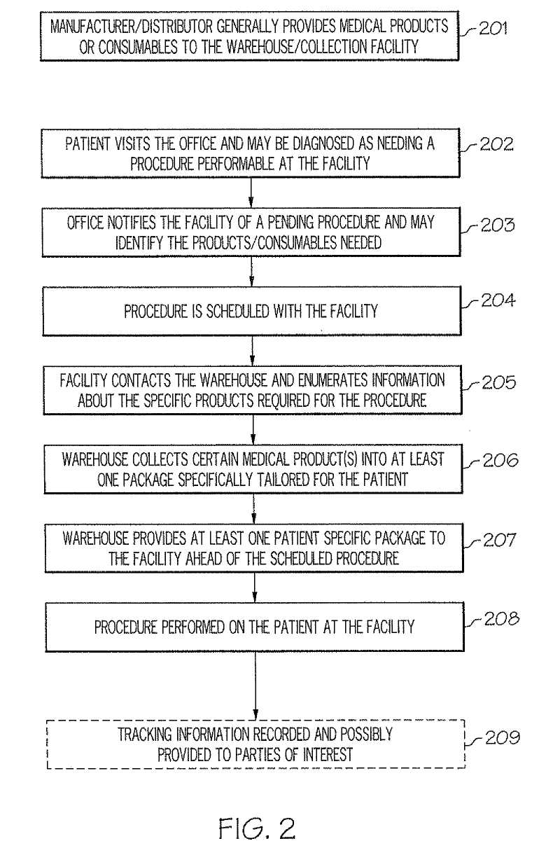

FIG. 2 is a flowchart generally illustrating one aspect of the operation of the present invention and design. As can be seen, at step 201 the manufacturer 101 provides medical products to the warehouse 102. Step 201 may take place before or after the patient visits the office 104 at step 202. At step 203, the office 104 notifies the facility 103 of a pending procedure, and may also identify the products needed for the procedure.

In some cases the sole information provided to the facility 103 by the office 104 is the nature of the procedure, such as a need to draw blood. In this case the facility 103 may compile and send a standard package based on the basic, standard, and well-known information relating to the procedure, based upon standards set by the facility 103 and office 104, and/or by the use of physician preference cards. At step 204, the procedure is scheduled with the facility 103, such as by use of the calendar 105. Once the procedure is scheduled, at step 205 the facility 103 contacts the warehouse 102 and provides a listing of the specific products required for the procedure, either as specified by the office 104 or as determined by the facility 103.

At step 206, typically at a time before the procedure is scheduled to occur, in some cases the day of or the day before the scheduled procedure, the warehouse 102 collects the specified medical products into a patient specific package which may, in one case, be specifically tailored for the patient/procedure, including any identifiers that may be desired and may assist in relating the package to the facility 103, the doctor or the patient. At step 207, the warehouse 102 provides the at least one patient specific package to the facility 103. At step 208, the procedure is performed by the medical practitioner on the patient at the facility 103 using the products in the patient specific package. At step 209, tracking information, typically indicating that the package or packages has been used, is recorded and provided to parties of interest, such as the manufacturer 101 and/or warehouse 102 by the facility 103, and such tracking information may further be provided to the doctor and/or the patient's electronic medical records.

Once the procedure is completed or phases of the procedure are completed, information relating to the completed procedure or phase(s), and/or the products used, and/or other ancillary information (such as recovery information, pre and post operative procedures) etc. may be transmitted from the facility 103 to the office 104. Thus in one embodiment, the fact that the procedure has occurred and been completed, and/or certain phases of the procedure have been completed, may be transmitted from the facility 103 to the manufacturer 101 and/or the warehouse 102. The transmitted information may include data about the procedure performed, the patient identifier, the package employed and/or the medical products or consumables employed, the attending physician, video and/or procedure data such as instrument data, and other relevant information. In some cases this information might also be transmitted to the manufacturer 101 and/or warehouse 102, which may store or use this information for billing or other purposes, such as marketing, teaching, statistical analysis, and so forth. One example of a system that provides both video and instrument data is provided in U.S. patent application Ser. No. 11/851,572, entitled “SYSTEMS AND METHODS FOR HISTORICAL DISPLAY OF SURGICAL OPERATING PARAMETERS,” by inventors Wayne S. Wong et al., filed Sep. 7, 2007, the entirety of which is incorporated herein by reference.

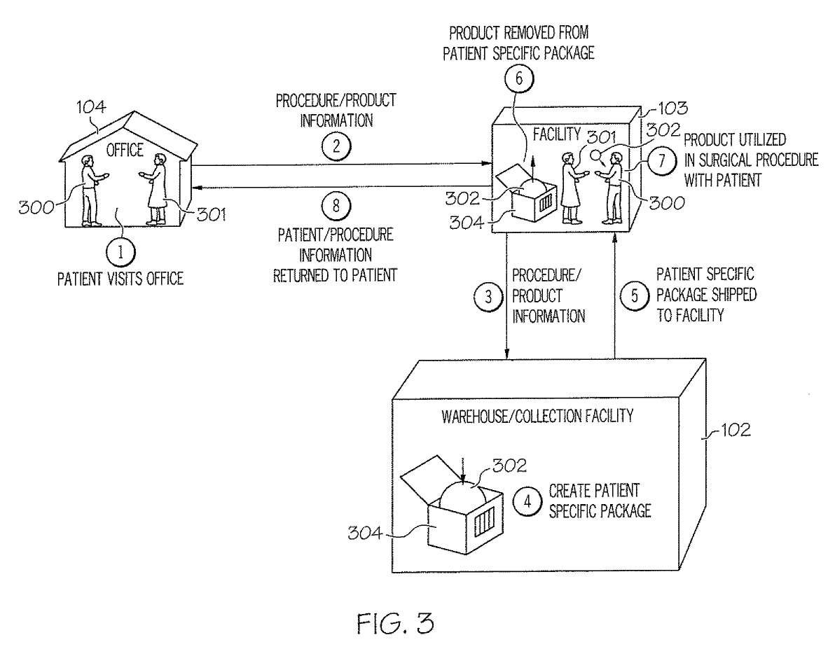

FIG. 3 is functional block diagram illustrating the flow of information, products, and patient specific packages in one embodiment of the invention. It should be understood that the flow of information, products, and patient specific products can differ from that shown in FIG. 3, and FIG. 3 illustrates just a single embodiment of the system and method disclosed herein. In particular, in the first step of FIG. 3, a patient 300 visits the physician's office 104, where a diagnosis is made, and the physician 301 identifies a particular procedure to be carried out at the facility 103 utilizing certain products. At the second step, this information, along with a patient identifier, is transferred to the facility 103. At the third step, the facility 103 transfers the relevant information to the warehouse 102. Using the information provided from the facility 103, the warehouse 102 then pulls the appropriate products 302 and places them in a patient specific package 304, as shown in the fourth step of FIG. 3. Further, the office 104 may provide the patient information, procedure information and/or specific package request directly to the warehouse 102 or the facility may request from the manufacturer (101 in FIG. 1) that a patient specific package be provided ahead of a procedure, and such information and/or products may be conveyed as appropriate. Also, multiple manufacturers may ship from various warehouses to several facilities, and the patient specific package prepared may include products from various manufacturers, distributors, warehouses, and/or collection facilities.

The patient specific package 304 is then transferred to the facility 103, as shown in the fifth step. Next, at the sixth step, the product(s) 302 are extracted from the patient specific package 304. At the seventh step, the products(s) 302 are utilized in a procedure utilizing the patient 300, including, in some cases, implanting the product(s) 302 into the patient 300, possibly by the same physician 301 who made the initial diagnosis/recommendation. Finally, in the eighth step of FIG. 3, the relevant patient and procedure information is transferred to the office 104.

The data transferred in the eighth step of FIG. 3, or otherwise tracked or maintained by the facility 103, may be specifically tied to a patient, and thus constitute, or form part of, the patient record, for example an electronic medical record or an actual physical medical file. For example, a video recording of the procedure may be electronically stitched or included with the patient record. In the ophthalmic example, during an IOL implant procedure, a phacoemulsification procedure may be carried out using a phacoemulsification machine to emulsify the patient's lens for removal. The phacoemulsification machine may include sensors, video capture technology or the like to capture and store details relating to the procedure, patient and products utilized during the procedure. For example, the time to complete various phases of the procedure, or the amount of energy or fluid used during various phases may be sensed, tracked and stored for later use, including as part of the medical records. Further, the inputted or scanned medical product information used in the procedure may also be included or stitched to the medical record.

In this manner, the video recording and sensor information is tied to the patent record and retained as a record which can be consulted for study, data mining, to establish compliance with regulations and standards of care, etc. Thus the manufacturer 101, warehouse 102, facility 103, office 104, or even some other party, may develop and maintain a multi-dimensional database of surgical procedures that include facts and information related to procedures, together with video and instrument data of the procedures and any other relevant available information.

For example, if a patient's blood pressure, or body temperature, drops below a certain level during surgery, that fact may be noted in the patient's record. A physician, manufacturer or other individual may then review the entire procedure, including video and/or instrument data to assess any unusual or noteworthy occurrences in the procedure. Thus any information that has virtually anything to do with the procedure or package may be collected, tracked, stored, and transmitted as appropriate.

After the procedure has been completed at the facility 103, or phases of the procedure have been completed, the facility 103 also advises the appropriate office 104 and forwards the relevant information as noted above. The office 104 receiving this information may either store the information, use the information to bill the patient and/or insurance and/or other entities as appropriate, or use the information for some other purposes, including but not limited to scheduling follow-up procedures, tracking statistics, allowing office personnel to review the surgery, or even transmit the information to third parties such as the manufacturer 101, warehouse 102, or another doctor's office 104.

This transfer of information, in the form of a complete and/or multi-dimensional record from the facility 103 to the office 104 is particularly advantageous as it enables a flow of information that mirrors the patient's movements. In particular, when a patient needs follow up care or further consolations, the patient typically goes to a physician's office 104, not to the facility 103. Thus, the rapid, real-time or near-real-time transfer of information regarding completed procedures, and utilized packages and/or products from the facility 103 to the physician's office 104 helps to “complete the loop” and provide information back to the physician's office 104 for review.

The system and method disclosed herein also helps to provide easy and seamless communication between multiple doctors' offices. For example, Doctor A may be a cardiac surgeon while Doctor B might be the patient's primary care physician. Doctor A may carry out a cardiac procedure at a facility 103. After the procedure is completed, the fact that the procedure occurred and the pertinent information associated with the patient, procedure, packages and/or products may be provided—in whole or part—from the facility 103 to Doctors A and B, or from the office of Doctor A to the office of Doctor B, etc.

An additional feature of the present invention design is the ability to track medical products shipped and/or used not only for payment purposes, but also for research, marketing and/or advertising purposes. The information tracked may be specific information associated with a particular procedure. In particular, as previously noted, medical products may be deployed or distributed on a consignment basis, and tracking of use was primarily limited to tracking how many products had left the shelves at a particular facility.

It can be highly valuable in marketing and advertising for a manufacturer to know or be able to state that a certain percentage of their products have been successfully employed with certain demographics, such as persons of certain ages, sexes, having known preexisting conditions, and so forth. For example, it can be useful to a heart stent manufacturer to be able to indicate that use of its product in males between 50 and 55 years of age, who have had at least two bypass surgeries, is effective in clearing blockages for at least one year in over X % of patients. As further examples, it can be useful to a manufacturer to be able to track use of its product across locales, across doctors or ASCs, by procedures, and/or in comparison to other manufacturers, e.g., a manufacturer may want to know to frequency or percentage of times that its product A is used with its product B, or with competitors analogous products. As may be appreciated, this holds true throughout various different medical or other fields.

The present system and method enables the collection of information associated with a procedure at a particular location, such as at either a physician's office 104 or at an ASC 103. A request may be provided from the physician's office 104 to the facility 103 including a patient identifier or patient code that specifically identifies the patient. Patient information may include name, age, sex, height, weight, blood type, etc. Other information associated and known to either the office 104 or the facility 103, such as history of related procedures, general health, specific known conditions, including but not limited to allergies, sensitivities, genetic traits, etc, may also be associated with the patient. Assuming this information is known to the physician or medical personnel at the physician's office, the information may be made available with appropriate security precautions to third parties having a need to know. Certain patient information, such as social security number, payment history, and other sensitive issues, may be classified as confidential and/or not distributed to other entities. However, more generic information regarding the patient may be made available to third parties having a need, or desire to know for statistical purposes.

Certain information that may be confidential on an individual basis may be able to be collected by third parties if the patients identity is sufficiently shielded or the information is aggregated or averaged across a number of patients. For example, the fact that a patient has AIDS may be confidential information with respect to the individual patient. However, that information may be provided to outside parties or to other medical providers under certain conditions, as long as providing such information is legal. For example, a manufacturer may have an interest in seeing how a product or procedure affects a patient or patients who have AIDS.

Information relevant to the patient and any procedure associated with the patient may be maintained at the office 104, facility 103, or in certain cases at the manufacturer 101 or warehouse 102 or at locations or entities associated therewith. For example, a server entity may maintain patient records, in an electronic format or otherwise, at a location offsite from a physician's office or hospital. The information may be classified as confidential (with potentially different levels of confidentiality) or non-confidential. When a procedure is performed, the information associated with the package, including its contents, and patient data, may be distributed from, for example, the ASC 103 to the manufacturer 101. By way of example, the ASC 103, warehouse 102 and/or an office 104 may inform the manufacturer 101 (or an ASC 103, warehouse 102 or an office 104) that two intra-ocular lenses—from one manufacturer or multiple manufacturers—of a certain prescription were implanted in a patient having certain patient characteristics (i.e. a 63 year old female, diagnosed with glaucoma, wearing glasses since age 36, blood type O positive, family history of heart disease, no previous ocular surgeries, etc.)

Once the manufacturer 101 collects the relevant data, the manufacturer 101 may provide or prepare a report or other informative information based on the collected data, such as a graph of the procedures provided by facilities in certain regions, by certain physicians, upon patients having certain characteristics, etc. Virtually any report can be created based on the information, including textual, graphic, numeric, or otherwise, reflecting information pertinent to the situation, such as the business of the manufacturer.

Such information and reports may be used in advertising or marketing products. Thus a manufacturer 101, for example, may have an ability to state that “our products have been successfully used in 100 percent of procedures in ASCs in the Pacific Northwest” or “our new products, when used in hip replacement surgery with Company A's artificial hip, cut the risk of infection 30 percent over our previous product.” Thus the present system and design provides the ability to collect specific information relating to particular procedures, including but not limited to patient data and package data, and employ the information collected to provide collective information about multiple patients and packages as desired.

As may be appreciated, patient records and information provided can be as sparse or as detailed as desired. Information not considered to be material at that time may also be transferred and tracked, as certain factors and characteristics not currently considered material can, at a later date, be found to be material. Patient confidentiality and privacy rights may be taken into consideration as appropriate. However, the mere transfer of information relating to a patient's medical conditions, which does not specifically identify or enable identification of the patient, may generally be acceptable.

A central location, as for example the manufacturer 101 or some other party, may compile reports from the various facilities 103, warehouses 102 and offices 104. Reports and information may thus be taken from multiple entities and compiled and cross-referenced based on individual products, product lines, manufacturers, related products, individual physicians, groups of physicians, patients having certain characteristics, particular facilities, or virtually any other desired criteria. Additional information may be compiled and available for review, such as physician notes, specific instructions, and so forth. The information can be maintained in a database and accessed or collected using database management software or other appropriate software known in the art.

As an example but not by way of limitation, information about ocular implant procedures may be maintained at a facility 103 where ocular implants are performed. Once a package (such as a patient specific package) is shipped to the facility 103, the package is checked in and its presence (as well as the products within the package) may be noted in a database. The facility 103 may then contact the physician's office 104 that initiated the request for the ocular surgery and request patient records for the patient. Non-confidential information about the specific patient may be provided from the office 104 to the facility 103 and maintained at the facility 103. The data about the package and/or its contents may then be linked, or associated, with information about the patient (linking or association may also occur during or after the procedure).

After the procedure is performed, information relating to the procedure, the patient, the package and/or items in the package may be transferred to a storage location, such as a database. This information may be forwarded or collected as desired, and optionally sent to an outside party, such as a manufacturer 101 or collected by a polling service, for example. In this manner, by sending the relevant usage information “upstream” to the manufacturer 101, the manufacturer 101 can track the usages of its products to more efficiently adjust its projections and manufacturing operations.

In an alternate example of data collection, the manufacturer 101 can periodically poll warehouses 102, facilities 103, and/or offices 104 for information related to products produced or distributed by the manufacturer 101. In this example, the information regarding packages sent from the warehouse 102 and/or manufacturer 101, and contents of those packages pertinent to the manufacturer 101, along with patient identification information, would be collected by the manufacturer 101 from each warehouse 102, facility 103, or office 104. In other words, information may be gathered on a package-by-package basis.

Alternately, the manufacturer 101 may collect information about the procedures performed at each facility 103 on a patient-by-patient basis by using patient identification information. The information gathered in this manner may relate to the specific procedure carried out in relation to that patient, its duration, the identity of the physician performing the procedure, issues arising during the procedure, and any other pertinent patient information. The information collected on a patient-by-patient basis may be compared to information gathered by the other manners noted herein.

Each of the functions described above may be provided or contained in its own module, which can be a block of software, code, instructions or the like which, when run on a computer, provide the desired functions. The software which carries out the system and method disclosed herein can take the form of one or more computer readable and/or executable instructions that cause a computer, personal electronic device or other electronic device to perform functions, actions and/or behave in a desired manner. The instructions may be embodied in various forms such as routines, algorithms, modules, methods, threads, and/or programs. The modules in the system may be functionally and/or physically separated, but can share data, outputs, inputs, or the like to operate as a single system and provide the functions described herein.

Each of the entities described herein, including the manufacturer 101, warehouse 102, facility 103, offices 104, and others may include software or parts thereof on their computers or the like to aid communication, and/or execution of the functional steps of the system and method disclosed herein. Moreover, one or more of these entities may maintain a web page, web site or the like which is accessible to one or more of the other entities to provide the communication, functionality, and access to records and databases described herein.

The specific embodiment of the design, system, method and invention presented herein are meant not to be limiting, and the design, system, method and invention may include alternate components while still incorporating the teachings and benefits of the particular aspects shown herein. While the design, system, method and invention has thus been described in connection with specific embodiments thereof, it will be understood that the design, system, method and invention are capable of further modifications. This application and disclosure is intended to cover any variations, uses or adaptations of the design, system, method and invention following, in general, the principles of the design, system, method and invention and including such departures from the present disclosure as come within known and customary practice within the art to which the design pertains.

The foregoing description of specific embodiments reveals the general nature of the disclosure sufficiently that others can, by applying current knowledge, readily modify and/or adapt the design, system, method and invention for various applications without departing from the general concepts. Therefore, such adaptations and modifications are within the meaning and/or range of claims and equivalents of the disclosed embodiments. The phraseology or terminology employed herein is for the purpose of description and not for limitation.

What is claimed is:

1. A method for providing a medical product comprising:
receiving a request for a medical product for use with a specific patient to be used at a particular location;
creating a patient specific package which includes said medical product;
associating at least one of said patient specific package or said medical product with the specific patient; and
causing the patient specific package to be delivered to said particular location;
wherein said medical product is a uniquely-identified medical product, and wherein the method further includes the step of recording a unique identifier of said medical product prior to said causing step.

2. The method of claim 1 wherein said receiving step includes receiving identification of a particular procedure in which said medical product is to be used, and wherein said patient specific package of said creating step includes ancillary medical products useful in said particular procedure based upon said identification of said particular procedure, and wherein said ancillary medical products are not specifically identified in said request.

3. The method of claim 1 further including the step of receiving information relating to the scheduled start of a procedure in which said medical product will be utilized, and wherein said causing step is carried out such that the patient specific package is delivered to said particular location prior to said scheduled start.

4. The method of claim 1 wherein the method further includes the step of receiving information relating to a medical procedure in which said medical product is to be used or has been used, and providing information about at least one of said medical product, said medical procedure or the specific patient to a manufacturing/distribution entity.

5. The method of claim 1 wherein the medical product is an ocular product to be used in an ocular surgical procedure.

6. The method of claim 1, further comprising, prior to the receiving step, evaluating the patient at an examination location, determining that the medical product should be used with the specific patient, and providing information regarding the medical product and the patient to the particular location.

7. The method of claim 1, further comprising, after the causing step, carrying out a medical procedure utilizing said medical product on said specific patient at said particular location.

8. The method of claim 1 wherein said request is sent from a location that is remote from said particular location.

9. A method for providing a medical product comprising:
receiving an identification of a medical procedure for use with a specific patient to be used at a particular location;
based upon said identification of said medical procedure, identifying a medical product for use in said medical procedure;
creating a patient specific package which includes said medical product;
associating at least one of said patient specific package or said medical product with the specific patient; and
causing the patient specific package to be delivered to said particular location.

10. A method for distributing medical products comprising:
receiving an indication of desire of a medical practitioner to carry out a medical procedure in conjunction with a specific patient;
in response to said receipt, scheduling the procedure;
in response to said receipt, providing a request to a medical distributor for a medical product associated with the procedure;
receiving the product in a patient specific package; and
making said product available for use by said practitioner in said procedure;
wherein said medical product is a uniquely-identified medical product, and wherein the method further includes the step of recording a unique identifier of said medical product after receiving said product.

11. The method of claim 10 wherein at least one of said patient specific package or said product is uniquely associated with said patient.

12. The method of claim 10 wherein said first receiving step includes receiving identification of a particular procedure without explicitly identifying said medical product, and wherein the method further includes explicitly identifying said medical product based upon said the particular identified procedure.

13. The method of claim 10 wherein said patient specific package includes a plurality of products for use in said procedure.

14. The method of claim 10 wherein said indication of desire includes information relating to the scheduled start of said particular procedure, and wherein said request provided to said medical distributor includes information relating to the scheduled start of said procedure.

15. The method of claim 10 wherein the method further includes the step of, after said making available step, providing information about at least one of the medical product, the medical procedure or the specific patient to a manufacturing/distribution entity to facilitate payment for or billing of the medical product.

16. The method of claim 10 wherein the method further includes the step of, after said making available step, providing information about at least one of the medical product, the medical procedure or the specific patient to a practitioner's facility which is remote from where the making available step is carried out.

17. The method of clam 16 wherein said provided information includes video information from a phacoemulsification machine, wherein said provided information is electronically included in a patient record.

18. The method of claim 10 wherein the medical product is an ocular product and said procedure is an ocular surgical procedure.

19. The method of claim 10 wherein said scheduling step includes assigning a status indicator to said scheduled procedure based at least in part upon an availability of said medical product, and wherein the method further includes modifying said status indicator based upon a change in availability of said medical product.

20. A method for collecting medical information comprising:
distributing a plurality of medical products for use in medical procedures in patient specific packages, thereby facilitating tracking of the contents of patient specific packages and associated patient data; and
accumulating patient specific package data and associated patient data for procedures performed using the distributed medical products.
